(19) United States
(12) Patent Application Publication
(10) Pub. No.: US 2013/0302440 A1
(43) Pub. Date: Nov. 14, 2013

(54) Antimicrobial surfaces

(71) Applicants: Joseph King, Wayzata, MN (US); John Hill, Plymouth, MN (US)

(72) Inventors: Joseph King, Wayzata, MN (US); John Hill, Plymouth, MN (US)

(21) Appl. No.: 13/815,433

(22) Filed: Mar. 1, 2013

Related U.S. Application Data
(63) Continuation-in-part of application No. 12/001,351, filed on Dec. 11, 2007.
Application No. 12/001,351 is a continuation-in-part of application No. 12/592,692, filed on Dec. 1, 2009, now abandoned.

(51) Int. Cl. A01N 59/16; A01N 43/50

(52) U.S. Cl. CPC A01N 59/16; A01N 43/50
USPC 424/618

(57) ABSTRACT

An antimicrobial structure surface therein wherein the structure surface includes an antimicrobial agent having a biocidal metal ion source and compound containing a hydantoin ring wherein the compound containing the hydantoin ring may or may not have antibacterial properties but the combination of the compound containing the hydantoin ring and the biocidal metal ion source when in the presence of a liquid coact to increase the level of available metal ions for killing microorganisms on the structure surface.

### CROSS REFERENCE TO RELATED APPLICATIONS

This application is a continuation in part of U.S. patent application Ser. No. 12/592,692 filed Dec. 1, 2009 titled Antimicrobial Surfaces (pending), which claims priority from provisional application Ser. No. 61/126,105 file May 1, 2008 and a continuation in part of U.S. patent application Ser. No. 12/001,351 filed Dec. 11, 2007 (pending), which claims priority from provisional application Ser. No. 60/878,016 filed Dec. 29, 2006.

### FIELD OF THE INVENTION

This invention relates generally antimicrobial surfaces and, more specifically, to antimicrobial structure surfaces having an antimicrobial agent thereon to prevent or eliminate bacteria and other harmful microorganisms on the structure surfaces.

### STATEMENT REGARDING FEDERALLY SPONSORED RESEARCH OR DEVELOPMENT

### None

### REFERENCE TO A MICROFICHE APPENDIX

### None

### BACKGROUND OF THE INVENTION

One of the health concerns for individuals is the presence of harmful bacteria and toxins in both a home environment and a business environment. It is known that bacteria and other microorganisms can remain in an active state on structure surfaces for an extended length of time. In addition the presence of water can cause the bacteria and other harmful microorganism to rapidly increase. As a result it becomes more likely that bacteria and other harmful microorganisms can be transferred from individual to individual through physical contact with the structure surfaces carrying the bacteria and other harmful microorganisms. In order to minimize the transfer of bacteria and other harmful microorganism through contact with structure surfaces the present invention provides antimicrobial structure surfaces that can reduce or eliminate harmful bacteria and other harmful microorganisms on structure surfaces thus limiting not only the presence of harmful bacteria and harmful microorganisms but the transfer of bacteria and harmful microorganisms.

### SUMMARY OF THE INVENTION

Briefly, the present invention comprises a method for enhancing the health and safety of structure surfaces through the use of structure surfaces containing an antimicrobial agent having a biocidal metal therein and a compound containing a hydantoin ring whereby the antimicrobial agent can kill or prevent growth of harmful microorganisms on the structure surface even in situations where the concentration of the biocidal metal in the antimicrobial agent may, when used alone, be insufficient to maintain a concentration of biocidal metal ions on the structure surfaces which is sufficient to kill bacteria and other microorganisms thereon. In one mode the antimicrobial agent in a dry or inactive can be incorporated into or placed on the structure surface and in another mode the antimicrobial agent can be applied to the structure surface with a carrier that is allowed to evaporate to leave the antimicrobial agent in an inactive state where the antimicrobial agent can be activated by the presence of a liquid.

In one example interior or exterior building structure surfaces, such as found on wallboard, fiberboard, wood laminate, roof tiles, insulation, conduits including air ducts and electrical conduits, water pipes, bathroom fixtures, bathroom surfaces, glass and doorknobs contain the antimicrobial agent.

In another example structure surfaces of cleaning products such as brooms, buckets, may be impregnated or coated with the antimicrobial agent to provide protection to the building occupants and the users.

In another example products used in buildings, namely structure surfaces found on containers such as pots, pans, bottles and the like can be impregnated or coated with the antimicrobial agent to provide protection to the users.

In another example, the structure surfaces may include liquid covering materials such as paints, varnishes or the like which contain an antimicrobial agent wherein the liquid covering material with the antimicrobial agent can be applied directly to structure surfaces such as buildings surfaces either after or before the building is erected.

In another example surface coatings may be applied to a structure surface found proximate pools, bathtubs, showers or the like to prevent growth of bacteria and other harmful microorganisms.

In another example the antimicrobial method includes applying the antimicrobial agent containing a metal ion donor and a compound contain a hydantoin ring in a liquid carrier can be applied to a structure surface with the liquid allowed to evaporate and leave the metal ion donor and the compound containing a hydantoin ring on the structure surface.

In another example the invention may includes an antimicrobial method where one forms a structure surface, applies an antimicrobial agent containing a source of metallic ions and a compound containing a hydantoin ring to the structure surface during the manufacturing process to thereby lessen or eliminate growth of bacteria and other harmful microorganisms on the structure surface.

### BRIEF DESCRIPTION OF THE DRAWINGS

FIG. 1 is a cutaway of a building showing typical structure surfaces and structure surfaces within a building that may benefit from the biocidal agent;

FIG. 2 shows an operator applying the antimicrobial agent to an exterior building surface;

FIG. 3 shows an enlarged view of a portion of a building surface with the antimicrobial agent located thereon;

FIG. 4 shows moisture in the form of a patch of water that is located on the building surface;

FIG. 5 shows a schematic of a hydantoin ring;

FIG. 6 shows a table showing dissolved silver concentrations;

FIG. 7 shows a graph of the measured dissolved silver concentrations each week for the duration of a Spa Study 1;

FIG. 8 shows a graph of the measured dissolved silver concentrations each week for the duration of a Spa Study 2 as compared to the theoretical calculations;

FIG. 9 shows a graph of is the measured dissolved silver concentrations each week for the duration of a Spa Study 3 as compared to the theoretical calculations;

FIG. 10 is a table showing the effect that the bathers have on the spa water of Spa Study 3.

FIG. 11 shows a dispenser having a housing with a compartment containing a source of N-halohydantoin and a silver ion donor comprising silver chloride therein; and

FIG. 12 shows a dispenser having a first housing containing a source of N-halohydantoin and a second housing containing silver ion donor comprising silver chloride therein.

FIG. 13 shows a dispenser.

### DESCRIPTION OF THE PREFERRED EMBODIMENT

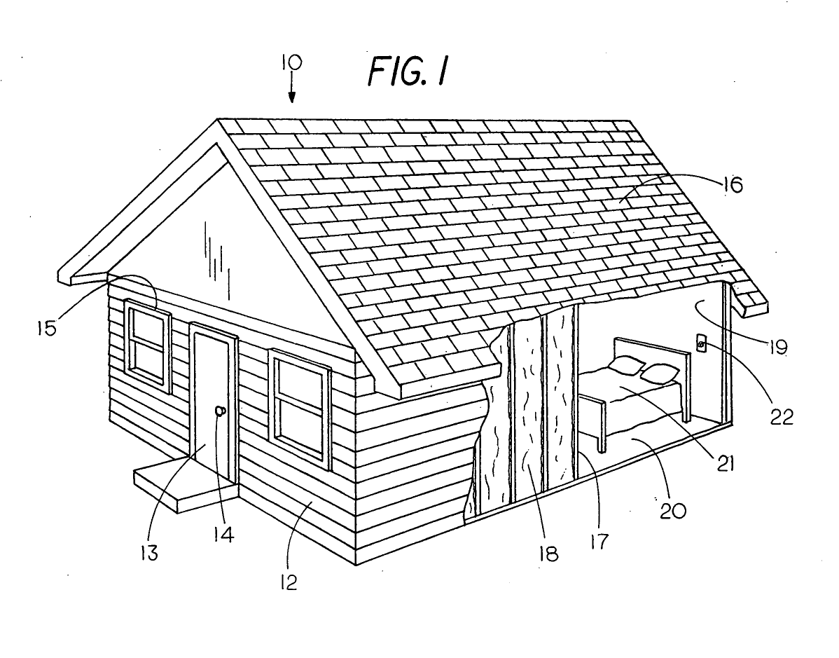

FIG. 1 is a cutaway of a building 10 revealing portions of the interior of the building and portions of the exterior of the building to illustrate examples of various types of structure surfaces that can be treated with an antimicrobial agent described herein to either kill or prevent formation of harmful bacteria and other harmful microorganisms that normally grows on the structure surface when there is moisture on the structure surfaces. Typically, the antimicrobial agent may be applied to the structure surfaces through spraying or though incorporating the antimicrobial agent directly into the structure surface during formation of the structure surface. For example, through use of an adhesive or by incorporating the antimicrobial agent directly into the structure surface.

Examples of exterior structure building surfaces which may receive the antimicrobial agent are illustrated in FIG. 1 and include siding 12, a door 13, a door knob 14 the windows 15 and the shingles 16. In addition, the antimicrobial agent may be applied to unexposed structure surfaces that are normally not exposed when a house or building is finished. For example items such as studs 17 and insulation 18 which are located between the siding 12 and the interior building wall 19 but when wet form areas where mold and other harmful microorganisms can grow. The antimicrobial agent can further be applied to interior structure surfaces of the building including ceilings and walls 19, floor 20, electrical fixtures 22 and furniture 21. As used herein structure surfaces includes those surfaces of the building that are an integral component of the building as well as the surface of those objects which may not be integral to the building but are considered part of the building, for example furniture which may be built in or may be moveable from room to room.

One of difficulties with use of biocidal metals, is that the solution that carries the antimicrobial agent on the structure surface may limit the effectiveness of the antimicrobial agent by limiting the availability of the biocidal metal ions. For example, it is known that limiting the available of biocidal metal ions may limit the effectiveness of the biocidal metal as a sanitizing agent. This is particularly true of biocidal sanitizing agents containing silver where the solubility of silver in water limits the concentration of available silver for killing bacteria. With the antimicrobial agent described herein is located a structure surface the structure surface has higher levels of metal ions than expected as a consequence of the combination of a biocidal metal source with a compound containing a hydantoin ring. Consequently, applying the antimicrobial agent to the structure surface lessens or eliminates growth of bacteria and other harmful microorganisms on the structure surface.

Another feature is that the structure surface with the antimicrobial agent thereon can remain in a passive state until wet or moist conditions occur which cause growth of bacteria and other harmful microorganisms. One of the features of the antimicrobial agent described herein is that when conditions for growth of harmful microorganisms are the greatest (i.e., when the structure surface is wet) the antimicrobial agent becomes a more effective antimicrobial agent since the presence of moisture forms a liquid carrier which increases the concentrations of available biocidal metal ions on the structure surface.

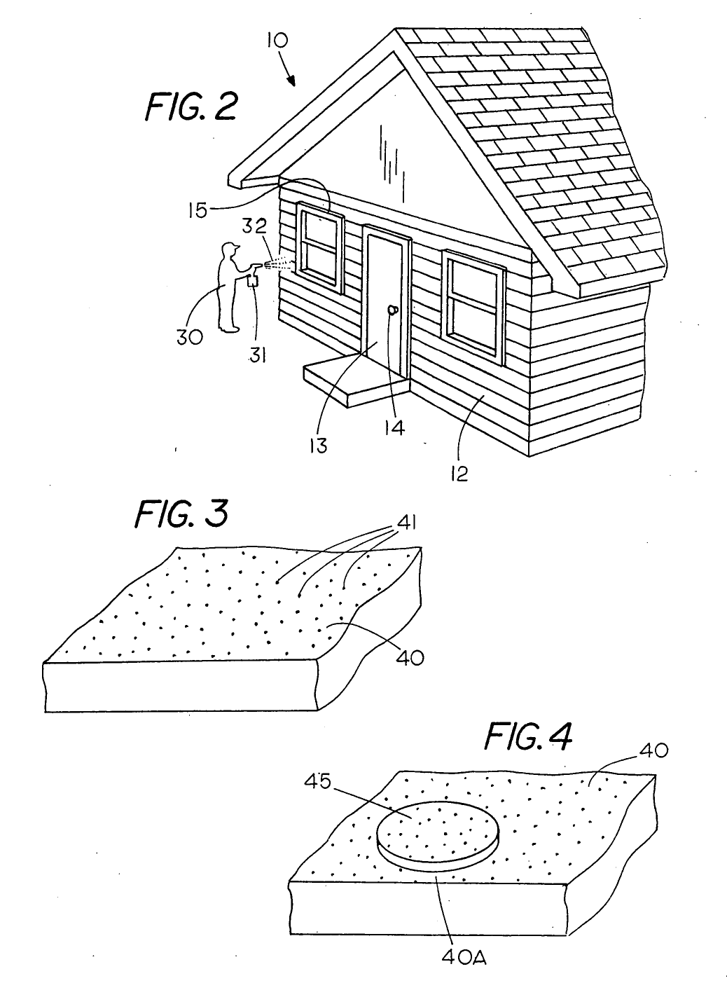

FIG. 2 shows an operator 30 applying an antimicrobial agent 32 to a building surface using a hand held sprayer 31. Spraying the antimicrobial agent on the building surface, i.e. the siding 12, is only one of many ways that the antimicrobial agent can be applied to the surface. For example, without limiting thereto the antimicrobial agent may be applied through inclusion with other liquid surface applied materials such as brush-on paints or varnishes. Other examples of application may include securing the antimicrobial agent to the structure surface through incorporation of the antimicrobial agent into the product during the manufacture of the product.

One of the aspects of the invention is that the presence of surface moisture with the antimicrobial agent increases the solubility of the biocidal metal ions and hence quickly increases the level of available metal ions and consequently the ability of the antimicrobial agent to rid the surface of bacteria and other harmful microorganisms.

FIG. 3 shows an enlarged view of a portion of a structure surface 40 wherein an antimicrobial agent 41 thereon has been applied to the structure surface 40. In one example, the biocidal sanitizing agent, which is adhered to the surface, includes silver chloride as a source of silver ions and a compound containing a hydantoin ring such as DMH. With no water present the growth of bacteria and other harmful organisms is general limited, however, once water is introduce bacteria and other harmful organisms can begin to grow rapidly. As shown in FIG. 3 the antimicrobial agent is dispersed throughout the structure surface but may have low antibacterial effect since there is no water present to act as a carrier for the silver ions. On the other hand without the presence of water there is little opportunity for the growth of bacteria and other harmful organisms.

FIG. 4 illustrates what happens when conditions for rapid growth of bacteria and other harmful microorganisms occur, namely the presence of water. In the embodiment of FIG. 4 reference numeral 45 identifies a patch of water, which is located on the surface 40. The presence of water creates conditions for the growth of bacteria and other harmful organisms. The presence of water on the surface may occur either from moisture in the air or from water being applied to the surface. In any event it creates condition for growth of mold as well as other forms of bacteria and other harmful microorganisms. As the water contacts the structure surface and the antimicrobial agent the water forms a carrier for the biocidal metal ions which can then be distributed to the area covered with water to kill bacteria and other harmful microorganisms. In addition, the presence of water also increases the solubility of the biocidal metal, which thereby increases the level of available biocidal metal ions. Biocidal metals include zinc, copper, silver and any other metals whose ions can kill bacteria or microorganisms.

FIG. 4 shows a bacteria and microorganisms killing zone of heightened biocidal activity that includes a surface region 40a within the patch of water 45 and a portion of the antimicrobial agent 41 wherein the antimicrobial agent includes a source of metal ions and a compound containing a hydantoin ring. In one example the antimicrobial agent includes a source of metal ions such as silver chloride and the compound containing the hydantoin ring is dimethylhydantoin.

Within the bacteria and microorganisms killing zone the antimicrobial agent 40 adheres to the structure surface 40 in a kill ready condition until the surface is wetted, for example by water, which causes the level of metal ions in the wetted region to increase. It will be noted that because the water acts as a carrier for the metal ions the size of the zone expands or contracts in response to size of the water wetted surface. Thus the size of bacteria killing zone may be increased by increasing the wetted area on the surface 40. Consequently, even accidental spills of water on the structure surface give rise to enhancement of the killing of bacteria and other microorganisms.

One of the limitations of the use of only a source of silver ions as an antimicrobial agent is that the solubility of the silver in water can limit the concentrations of available silver metal ions to kill the bacteria and other harmful microorganisms thus rendering the antimicrobial ineffective for a particular use. However, with the use of a biocidal metal with a compound containing a hydantoin ring one can increase the effectiveness of the antimicrobial agent because the solubility of the metal ions in the water increases in the presence of the compound containing a hydantoin ring. For example, when an unhalogenated hydantoins such as 5,5-dimethylhydantoin is used with the source of metal ions one obtains a higher level of biocidal metal ions than if antimicrobial agent were used without the 5,5-dimethylhydantoin.

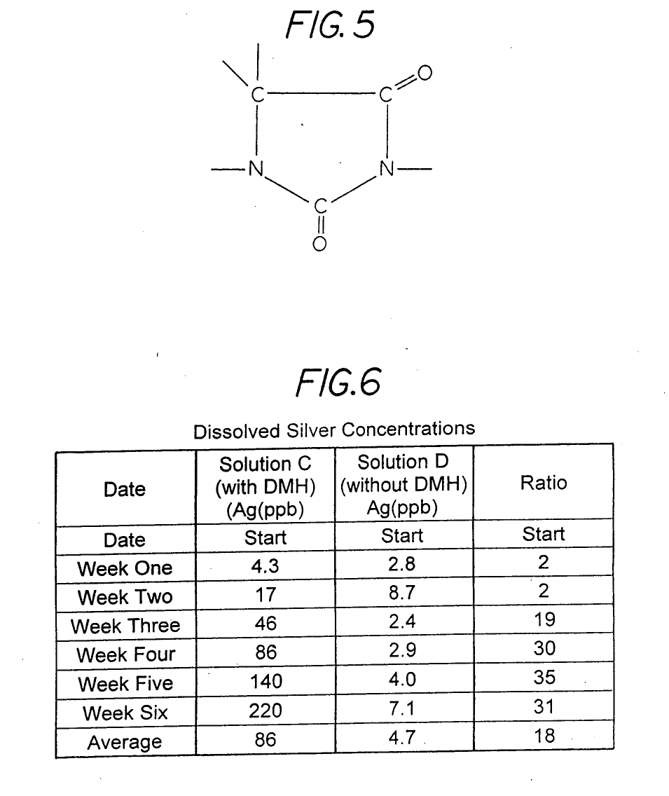

FIG. 5 shows a schematic of the structure of a hydantoin ring with carbon and nitrogen atoms joined in a five-sided ring. An oxygen atom is attached to two of the carbons in the hydantoin ring. The lines extending from the third carbon atom and the nitrogen atom indicate that other atoms could be attached thereto. For example, in a compound containing a hydantoin ring, such as DMH (5,5-dimethylhydantoin), two methyl groups would be attached to the carbon atom an a hydrogen atom would be attached to each of the two nitrogen atoms.

It has been found that compounds containing a hydantoin ring such as 5,5-dimethylhydantoin (DMH), while lacking antimicrobial properties, do have the ability to interact with metal ion donors including silver metal ion donors to increase the solubility of the silver ions in a liquid environment and thereby increase the effectiveness of the antimicrobial process. While a number of compounds with a hydantoin ring may be used as a practical matter one may want to avoid those compounds where the group or groups on the compound may have an adverse effect on the product. On the other hand one may want to include those compound containing a hydantoin ring, which in themselves may have an antimicrobial effect.

Examples of other well known compounds wherein the compound contains a hydantoin ring include silver dimethylhydantoin 1-hydroxymethyl-5,5-dimethlyl hydantoin, glycolyurea and Copper hydantoin, Hydantoin-5-acetic acid, and Imidazolidines including parabanic acid, 2-Thiohydantoin, hydantoin purum, hydantoin, 1-Aminohydantoin hydrochloride,2-Imidazolidone, 2-Imidazolidone purum, 2-Imidazolidinethione, 2-hydrazino-2-imidazoline hydrobromide, 2-oxo-1-imidazolidinecarbonyl chloride, 1-methylhydantoin, 5-methylhydandtoin, 2-imidazolidone-4-carboxylic acid, allantoin, allantoin purum, creatinine anhydrous, creatinine biochemika, creatinine hydrochloride, 2-methyl-2-imidazoline, 2-methylithio-2-imdazoline hydrodide, 3-bromo-1-chlor-5-5-dimethlyhydantoin, 1-3-dibromo-5,5-dimethlyhydantoin purium, 1-3-dichlorol-5,5-dimethylhydantoin, 1,3-dichlor-5,5-dimethyl hydantoin, hydantoin-5-acetic acid. 2-chlorocarbonyl-1-methanesulfonyl-2imidazolidinone, 5.5-dimethylhydantoin purum, 5,5-dimethylhydantoin, 2-imino-1. imidaolidineacetic acid, 1,3-dimethyl-2-imidazolidinone puriss, 1,3-dimethly-2-imidazolidinone purum, 1,3-dimethyl-2-imidazolidinone, 1-(2-hydroxyethyl)-2-imdazolinone, 1,5,5-trimethlylhydantoin, 5-ethyl-5-methylhydantoin, 2-phenyl-2-imidazoline purum, 2-(4,5-dihydro-1 h-imidazoyl)-2-phenol, 4-(4,5-dihydro-1H-imidazol-2yl)phenylamine, 5-methyl-5-phentylhydantoin, 2-benzylimidazoline, 4-(4-methyl-4,5-dihydro-1H-imidazol-2-yl)phenyl, Imidazolidinyl urea, 4-hydroxymephenyloin, triethoxy-3-(2-imidazolin-1-yl)propysiliane purum, 1,(p-tosyl)-3,4,4-trimethylimidazolidine, naphazoline nitrate purisss, 5,5,diphenyl-2-thiohydantoin, 5-(4-hydroxyphenyl)-50phenylhydantoin, 5-(p-methylphenyl)-5-phenyhydantoin,1,3,bisbensyl-2-oxoimidazoline-4,5-dicarboxylic acid. Other examples of hydantoins are listed in European patent EP0780125, which is hereby incorporated by reference. The above list compounds with a hydantoin ring is illustrative and no limitation thereto is intended.

It was found that a silver ion donor in the presence of a compound containing a hydantoin ring such as DMH has a level of free silver higher than anticipated when compared to the silver ion donor in a water environment without the DMH. The results suggest that DMH enhances the solubility of the silver thereby increasing the antimicrobial effectiveness.

In order to verify that a compound containing a hydantoin ring, such as DMH, interacts to increase the solubility of insoluble silver in a water environment, a test was performed using either silver chloride or silver bromide as the donor of silver metal ions. The test demonstrated the enhancement of silver in a water environment when DMH is used in combination with a source of silver ions.

### Example

Silver bromide was initially prepared from a saturated sodium bromide solution, combined with silver nitrate in solution. The yellow precipitate, silver bromide, was than purified by filtration and washing. Additionally, the solid was allowed to dry before use.

A buffer system having a pH of 7.41 was prepared by adding Fisherbrand® potassium phosphate monobasic-sodium phosphate dibasic buffer to 2 Erlenmeyer flasks filled with 1000 mL of purified water. The first flask was treated with 1.12 grams of 5,5-dimethylhydantoin (DMH) and marked solution “C” (with DMH) and the second flask was left untreated and marked solution “D” (without DMH) for control. In regards to the 5,5-dimethylhydantoin (DMH), the 5,5-dimethylhydantoin (DMH) comprised 97% reagent grade was obtained from Aldrich® (CAS No. 77-71-4, Cat. No. D161403-1KG).

After the initial set-up, approximately 0.10 grams of dried silver bromide was introduced into dialysis tubing (Fisherbrand®, 45 mm, MWCO 12,000-14,000) along with purified water. The ends of the dialysis tubing were clamped to contain the silver bromide and purified water. Next, the outside of the dialysis tubing was rinsed several times to ensure that silver bromide residue was not on the outside of the dialysis tubing. A string was then tied to one clamp, and one tube was introduced into each flask. A magnetic stir bar was used to mix the solutions.

During the period of the test, a 100 ml sample were removed from solution “D” (without DMH) and solution “C” (with DMH) at weekly intervals and analyzed for their pH using Orin Perphect Meter 370 and analyzed for their silver ion concentrations using atomic absorption spectrometry.

FIG. 6 shows a table containing a list of the dissolved silver concentration, in parts per billion (ppb) obtained from the 100 ml samples for solution “D” (without DMH) and solution “C” (with DMH) at each of their respective weekly time intervals. The average concentration of dissolved silver for solution “C” (with DMH) was 86 ppb while solution “D” (without DMH) had an average concentration of dissolved silver of 4.7 ppb.

A week after the start date, the concentration of dissolved silver for solution D (without DMH) was at 4.3 ppb, while the concentration of dissolved silver for solution C (with DMH) was at 2.8 ppb. By the end of the testing, 6 weeks later, the concentration of dissolved silver for solution C (with DMH) had increase to 220 ppb, while the concentration of dissolved silver for solution D (without DMH) was 7.1 ppb. That is, by the end of the 6 weeks test, the concentration of dissolved silver was at least 30-fold greater in solution C (with DMH) then for solution D, (without DMH).

In summary, the results of the above testing confirmed that in a solution containing silver bromide, the presence of compound containing a hydantoin ring, such as DMH, leads to a higher dissolved silver concentrations than compared to a control solution containing silver bromide without the presence of the DMH. These results suggest that compounds containing a hydantoin ring interact with silver to form a soluble complex even if the source of silver comprises an extremely insoluble silver salt such as silver bromide.

In regards to generating a level of silver ions, the King Technology, Inc. Frog® Mineral Cartridge provides one method of delivering silver ions in the form of solid silver chloride (AgCl) distributed over a porous matrix. The water releases the soluble silver ions into the water environment with the DMH resulting in the formation of ionic-hydantoin structures. It would be anticipated that soluble silver ions would be depleted from the water environment through the formation of silver bromide, an insoluble salt. However, as shown in FIG. 6 after the DMH was added to the water environment, the actual silver concentrations were higher than the calculated theoretical silver concentration.

It is noted that various insoluble or slightly soluble transition metal salts may also be used in the present invention as a source of silver ions. Examples of insoluble or slightly soluble transition metal salts suitable for use in the present invention include, but are not limited to, AgCl, AgBr, AgI, Ag₂S, Ag₃PO₄, NaAg₂PO₄, CuS, and NaCuPO₄. Other examples of silver compounds include, but are not limited to, AgNO₃, Ag₂CO₃, AgOAc, Ag₂SO₄, Ag₂O, [Ag(NH₃)₂]Cl, [Ag(NH₃)₂]Br, [Ag(NH₃)₂]I, [Ag(NH₃)₂]NO₃, [Ag(NH₃)₂]₂SO₄, silver acetoacetate a silver benzoate, a silver carboxylate, silver amine complexes such as [Ag(NR₃)₂]X, where R is an alkyl or aryl group or substituted alkyl or aryl group and X is an anion such as, but not limited to, Cl⁻, Br⁻, I⁻, OAc⁻, NO₃⁻ and SO₄²⁻.

Although the use of the silver ion donor such as silver, silver oxide, silver salt, or a combination thereof have been disclosed in the present invention, various types of silver alloys may also be used as a source of the silver ions. The silver may be used as a stand-alone or in its pure/elemental or alloyed form or coated or impregnated to a substrate and placed on the structure surface. In addition, to other types of silver ion donors, other types of transition metals, a transition metal oxide, or a combination thereof, and other alternative bactericides whose solubility can be changed in the presence of compound containing a hydantoin ring can also be used in the present invention.

In the example, the preferred level of the DMH present on the surface of the structure surface is at least 5 ppm and preferably between 5 and 25 ppm for most applications with the DMH and the source of silver cooperating to maintain a level of silver ions present in the amount of at least 1 to 3 ppb and/or alternatively cooperating to maintain a level of silver ions present to sustain a standard plate count at 35 degrees F. of less than 200 colonies per milliliter. However, as the test results show the level of silver can be much higher.

In one example the invention includes a structure surface sanitizing method where one forms a structure surface and applies an antimicrobial agent containing a source of metallic ions and a compound containing a hydantoin ring to the structure surface to thereby lessen or eliminate growth of bacteria and other harmful microorganisms on the structure surface.

The application of the antimicrobial agent to the structure surfaces may be done with a carrier such as a water base solution with the water allowed to evaporate leaving a coating of the antimicrobial agent on the structure surface.

In another example the structure surface may comprise building surfaces wherein the building surfaces includes a plurality of indoor and outdoor surfaces having an antimicrobial agent thereon wherein the antimicrobial agent including a biocidal metal and a compound containing a hydantoin ring have been incorporated directly into the structure surface through adhesives or pressure. The presence of a liquid such as water on the building surfaces causing an increase in the antimicrobial activity of the biocidal metal to lessen or destroy harmful bacteria or microorganisms thereon. In other examples the structure surface may be on items that are routinely used in the buildings or come into contact with structure surfaces such as brooms, appliances, vacuums, buckets, utensils, tools, garments and the like.

While the antimicrobial agent can be applied to a structure surface before the growth of bacteria or harmful organisms the antimicrobial agent may be applied to surface with bacteria and other harmful organisms are present. For example, the invention may include a method of treating a building product to kill microorganisms on a surface by: (1) adding a source of biocidal metal, such as silver chloride, to a water base to generate biocidal metal ions in the water; and (2) adding a compound having a hydantoin ring, such as 5,5-dimethylhydantoin to interact, with the biocidal metal to enhance the biocidal metal ion concentration before applying the antimicrobial agent to the surface to quickly kill bacteria and harmful microorganism thereon.

The aforementioned method of applying the antimicrobial agent may include the step of impregnating the building products prior to assembly of the building products and preferably at the point of manufacture. Alternately, the antimicrobial agent can be applied after construction through spraying or brushing the antimicrobial agent on to the structure surfaces. For example, structure surfaces such as keyboards for electronic devices may be sprayed with the antimicrobial agent to provide enhanced bacteria and microorganisms killing ability.

Hydantoin structures are known complexing agents in silver-plating processes (R. J. Morrissey, U.S. Patent Application Publication no. 2005/0183961). Studies performed by the inventor have demonstrated that unhalogenerated hydantoins, such as 5,5-dimethylhydantoin (DMH), tend to increase levels of dissolved silver. Studies performed by the inventor have also demonstrated the halogenerated hydantoin such as Bromochlorodimethylhydantoin (BCDMH) also tends to increase levels of dissolved silver. While not fully understood it is believed that the aforementioned increased in solubility is due to the soluble complex between silver and hydantoin ring structures as it has been found the silver remains soluble to a higher degree than expected.

The present invention has found that the qualities to interact with metal ion donors such as silver chloride or silver bromide to increase the solubility of the silver chloride or silver bromide in a water environment and aid in the disinfection process is not limited to just the halogenerated hydantoin BCDMH alone but may include a broader category of N-halohydantoin compounds. For example, the inventor has discovered that in addition to BCDMH, the N-halohydantoin compound Dichlorodimethylhydatoin (DCDMH), which has been used commercially in household automatic toilet bowl cleaners and urinals, may also properly interact with silver from sources such as silver chloride or silver bromide in a body of recreational water such as spas, jetted tubs, swimming pools or the like to form a soluble complex to enhance the effectiveness of the silver in killing or controlling microorganisms in the body of recreational water.

In order to verify the above, spa tests were performed using silver chloride as the donor of metal ions to demonstrate the enhancement of a silver concentration in a body of water when other types of N-halohydantoin compounds such as DCDMH were used in combination.

In the tests, a 450-gallon Marquis® brand spa was used in performing 3 tested to evaluate the potential use of DCDMH to increase silver solubility in the presence of alternative disinfection systems such as sodium bromide. The spa comprised a dimensioned of 90″×90″×35.5″ with a water depth of approximately 25″ without bathers. The spa featured 43 jets and two pleated filter cartridges (Unicel 5CH-502), each having a filtration area of 50 square feet. Spa water was maintained between 100° F. (37.8° C.) to 104° F. (40° C.) and was circulated at least 2 hours daily.

In all three tests, the Dichlorodimethylhydantoin (DCDMH, CAS No. 118-52-5) used was obtained from two sources, namely Aldrich® and Lonza, Inc. located in Fair Lawn, N.J. The DCDMH obtained from Aldrich® comprised a fine powder material of 1,3-Dichloro-5,5-dimethylhydantoin with a 98% purity. The Lonza DCDMH (Dantochlor®) comprised a combination of 80-83% 1,3-Dichloro-5,5-dimethylhydatoin, 16-17% 1,3-Dichloro-5-ethyl-5-methylhydatoin, 0-2% monochloro-5-methylhydatoin. The DCDMH was introduced into the spa via spa cartridges, which were fabricated by adding approximately 75-100 grams of DCDMH or Dantochlor to an empty Spa Frog® BCDMH cartridge.

The source of silver ions was obtained from a King Technology Inc. Spa Frog® Mineral Cartridge, which was randomly selected from King Technology Inc.'s production inventories for use in these tests and installed into an in-line system on the spa. These mineral cartridges release silver ions into the spa in the form of silver chloride. A different cartridge was used in each of the three studies.

During all three tests, the spa was filled with fresh water prior to the initiation of each of the three tests and the water balanced according to Taylor Technologies Pool & Spa Water Chemistry Manual. The pH of the water was reduced by the addition of sodium bisulfate (pH Down Balancer, GLB, Alpharetta, Ga.) to a range between 7.2 and 8.0. In Studies 2 and 3, a cartridge containing the DCDMH was then installed into the In-Line Frog System of the spa at the same time that the Spa Frog Mineral Cartridge (silver source) was installed into the In-Line Frog System of the spa. In Study 1, a Spa Frog® Mineral Cartridge (silver source) was installed into the In-Line Frog System of the spa. A cartridge containing the DCDMH was installed into the In-Line Frog System of the spa three weeks after the start of the testing period.

In Spa Study 1, water samples were taken and tested for a ten-week period. In Spa Study 2, water samples were taken and tested for a seventeen-week period. And for Spa Study 3, water samples were taken and tested for a seven-week period. It is noted that in Spa Study 3, bathers were also introduced to the spa water three weeks after the start of the testing period to test the affect that bathers had on the spa water.

The Spa Frog® Mineral Cartridge was used to provide silver ions from solid silver chloride (AgCl) distributed over a porous matrix. Water flowing through the matrix comes into contact with the AgCl resulting in the release of soluble silver ions to water. DCDMH is also released to water resulting in the formation of free chlorine and hydantoin structures. It would be anticipated that soluble silver ions would be depleted from spa water through the formation of silver chloride, an insoluble salt. However, during each of the three spa studies the actual silver concentration was higher than the calculated theoretical silver concentration. This is due to the formation of a novel silver-hydantoin complex, which we previously described. Although silver chloride is described above as providing for the source of silver ion, in the present embodiment the source of silver ion may also comprises pure silver, silver metals, silver alloy or some combination thereof because of the recognized bactericidal, viricidal, and algaecidal properties of silver. The silver metals can be introduced as metallic, zero valence material, or as metal ions that can be introduced into the water by dissolution of soluble metal salts, or by the dissolution of the metal itself. For example, silver ion can be introduced into the water through the dissolution of silver nitrate, or through the dissolution of metallic silver as the result of conversion to silver oxide and subsequent conversion of the oxide to more soluble silver species. Mixtures of different salts, or of salts with metallic material, may be combined together to provide the necessary concentration of metal ions in the water.

### Water Testing

Chemical tests were performed with water samples obtained from each of the three spa studies for the chlorine concentration and also, the dissolved silver concentration. Additionally, the spa water's total alkalinity, turbidity, and pH were also tested and maintained within ranges accepted by the industry. The ideal pH for a spa is 7.20 to 7.60, however wider ranges are acceptable. In the studies, the average pH for Spa Study 1 was 7.31, Spa Study 2 showed an average pH of 7.27, and Spa Study 3 had an average pH of 7.37, which were all within the low end of the ideal pH for a spa.

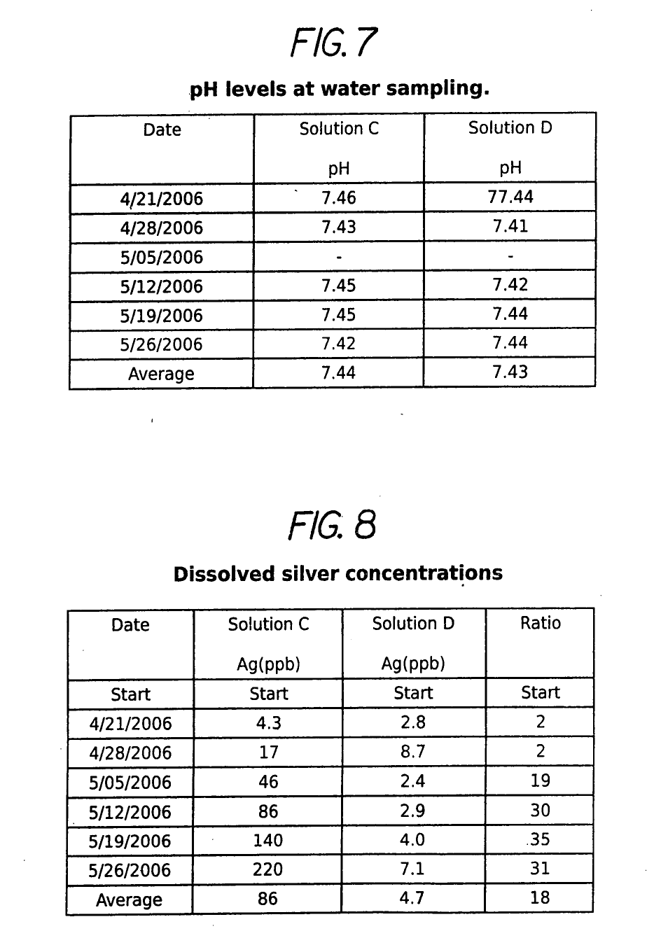

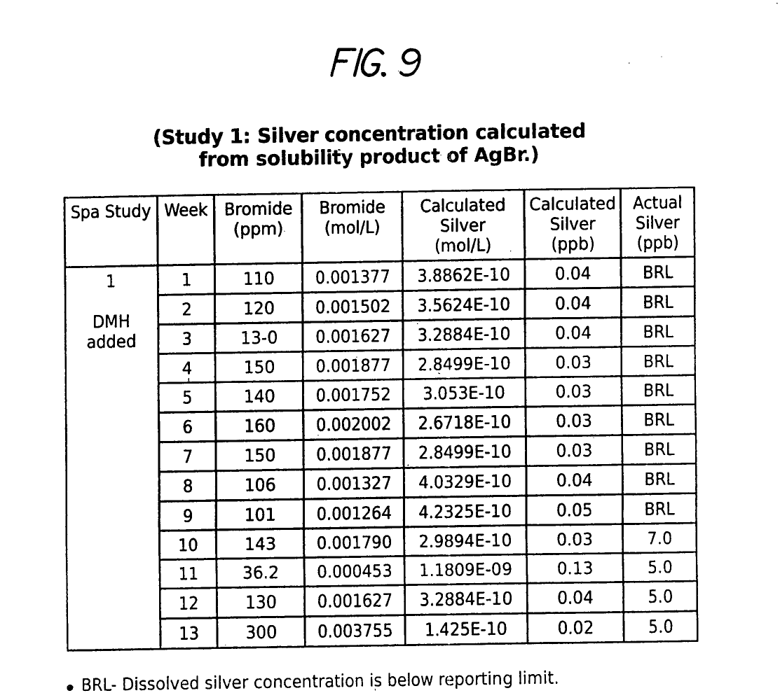

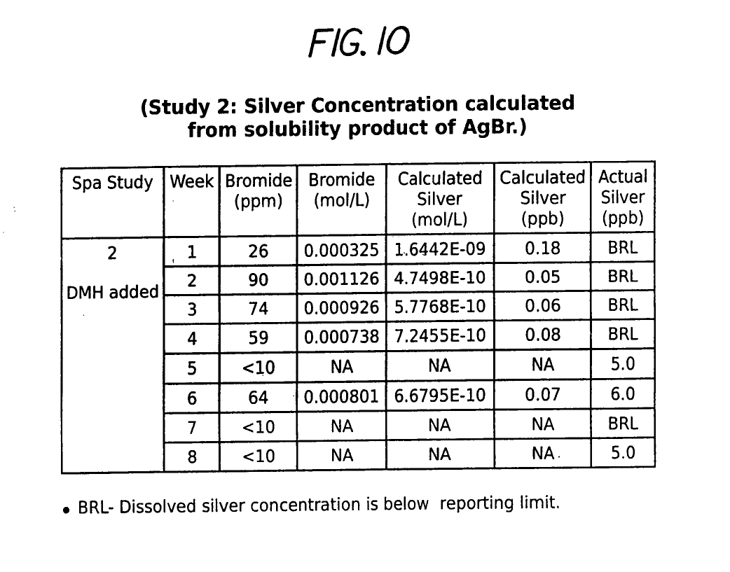

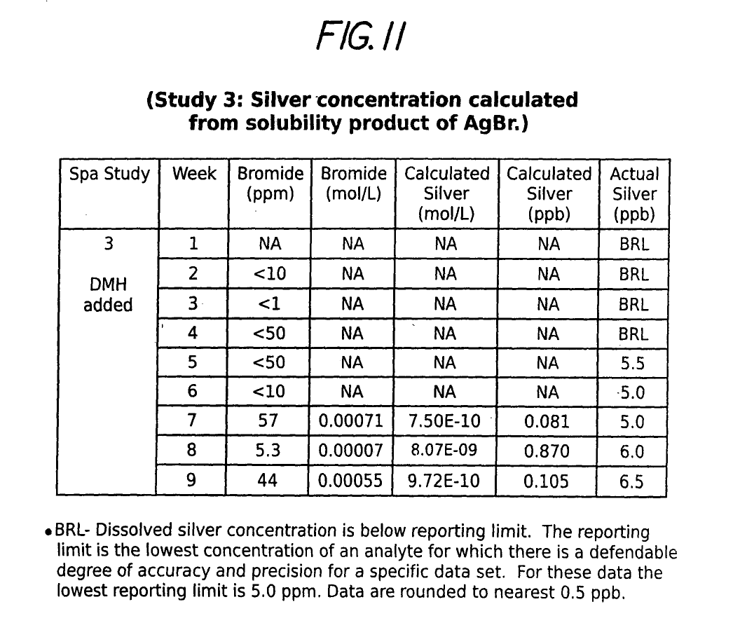

Result of the test for dissolved silver concentration are shown in FIG. 7 for Spa Study 1, are shown in FIG. 8 for Spa Study 2, and are shown in FIG. 9 for Spa Study 3. Chloride was tested during Spa Studies 2 and Spa Study 3 to provide a means to calculate the theoretical silver concentration based on the solubility product of silver chloride. FIG. 10 shows the effect that the bathers had on the spa water of Spa Study 3.

Free chlorine was measured to assess oxidizing potential for disinfection. The average levels of free chlorine in Spa Studies 1, 2, and 3 were 0.52 ppm, 0.68 and 0.79 ppm. Control of free chlorine concentrations in the observed range has not been previously possible when a solid source of chlorine has been dispensed from a simple cartridge device. It should be noted that although the aforementioned low levels of chlorine may be inadequate when DCDMH is used alone, the low levels of chlorine may be ideal for a combined used with Spa Frog Minerals. Therefore, DCDMH may be considered as an effective candidate for use with minerals in spas.

Total chlorine was measured to assess all forms of chlorine containing species present in spa water, some of which do not participate in the disinfecting process. The average total chlorine concentration for Spa Study 1 was 3.45 ppm (0.10 to 6.90 ppm range), Spa Study 2 averaged 6.16 ppm (range 0.12 to 14.4 ppm), and Spa Study 3 averaged 8.17 (range 0.17 to 15.8).

DCDMH's higher than expected concentrations of total chlorine can be contributed to the structure in that DCDMH has two chlorine atoms attached to a hydantoin ring.

Additionally, it is believed that only one chlorine atom detaches from the ring, while the second may remain bonded. The hydantoin backbone with the one chlorine atom attached may possibly interact with the DPD reagent used to test for the total chorine resulting in higher total chlorine reading than what really is present.

Furthermore, the high total chlorine can be utilized as a chlorine bank, when there is a high demand. That is, it is reasonable to propose that the last chlorine atom detaches itself from the hydantoin ring with higher demand for use in the disinfection process such as in the presence of high bather load demand. Also, a decrease in total chlorine concentration has been observed after the bathers exit the spa. Moreover, when the chlorine cartridge is empty the chlorine bank begins to fall and can be used as an indication that the cartridge needs to be replaced. Typically one DCDMH cartridge filled with 100 grams of DCDMH will last about 3-4 weeks depending on spa use. In view of the aforementioned, the total chlorine level may be monitored in the spa water to determine the quantity of chlorine that remains in the cartridge while the free chlorine level may be monitored in the spa water to determine disinfection potential.

FIG. 7 shows a graph of the measured dissolved silver concentrations each week for the duration of the Spa Study 1. The average dissolved silver concentration for Spa Study 1 was 16 ppb. During week 10 the chlorine measured 160 ppb. The level of silver that would be anticipated based on theoretical calculations of the chlorine would be about 4.2 ppb, however, the actual measured silver was 23 ppb. This is almost a 6-fold greater than would be anticipated.

FIG. 8 shows a graph of dissolved silver concentrations each week for Spa Study 2 as compared to the theoretical calculations based on the chlorine measurement. The average dissolved silver concentration for Spa Study 2 was 13 ppb. By the end of Spa Study 2 the measured level of silver was at least 3-fold greater than would be anticipated based on theoretical calculations.

FIG. 9 shows a graph of the dissolved silver concentrations each week for the duration of the Spa Study 3 as compared to the theoretical calculations based on the chloride measurement. The average dissolved silver concentration for Spa Study 3 was 11 ppb. By the end of Spa Study 3 the measured level of silver was at least 5-fold greater than would be anticipated based on theoretical calculations. It appears from Spa Study 3 that bathers do not have an affect on dissolved silver concentrations. It is believed that Spa Study 3 had the lowest average silver concentration because the Spa Study 3 was run for seven (7) weeks compared to the testing duration of twelve (12) and eighteen (18) weeks for Spa Study 1 and 2, respectively. It is anticipated that if Spa Study 3 had been tested longer in duration the average dissolved silver concentration would have mostly likely been higher.

The above results of Spa Studies 1, 2, and 3, as shown in FIGS. 7, 8, and 9 thus support the finding that the combination of other types of N-halohydantoin compounds such as DCDMH with a metal ion donor such as silver chloride enhances a concentration of metal ions in a body of water by retaining or increasing the solubility of metal ions from other metal ion donors to retain the antimicrobial activity of the metal ions in the body of water.

Per the inventor's above findings, it is anticipated that N-halohydantoin compounds of the formula shown below can be used in this invention.

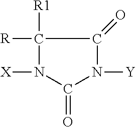

### Where

X is either H, Cl, or Br;

Y is either H, Cl, or Br;

R is an Alkyl group; and

R1 is an Alkyl group.

R and R1 are independently selected from alkyl groups (having from 1 to a plurality of carbons), and X and Y are independently selected from bromine, chlorine and hydrogen. In further regards to the above, as evidenced by the Inventor's use of the Lonza DCDMH (Dantochlor®), which comprised a combination of 1,3-Dichloro-5,5 dimethylhydatoin, 1,3-Dichloro-5-ethyl-5-methylhydatoin, and monochloro-5-methylhydatoin, a mixture of the derivatives of the above N-halohydantoin compounds can also be used.

FIG. 10 is a table showing the free chlorine concentration before and after two bathers used the spa for thirty (30) minutes increments on sequential days. The first columns correspond to the free chlorine level prior to the bathers entering the spa. The second columns represent the free chlorine level after the bathers exited the spa, and the third columns show the free chlorine concentration two hours after the bathers have exited the spa. Typically the next day after each bathing event the free chlorine stabilized between 0.5 and 1.0 ppm free chlorine even if 2 hours after spa use the free chlorine measured above 1.0 ppm. FIG. 10 also shows that when the free chlorine level is below 0.5 ppm, and bathers used the spa, the free chlorine goes up, instead of down. This can be attributed to the above-discussed chlorine-hydantoin bank, because as the demand for free chlorine goes up, the hydantoin releases the second chlorine on the ring to add to disinfection. Also the additional circulation from the jets of the spa and/or increases in water temperature may cause more DCDMH to dissolve into the spa water, and possibly increase the kinetics of the reaction.

The above results of Spa Studies 1, 2, and 3 show that: (1) spa water chlorine concentrations can be controlled when DCDMH is dispensed from a cartridge; (2) at a fixed cartridge setting, chlorine concentrations can be maintained at levels of 0.5 to 1.0 ppm and higher as needed; (3) concentrations of actual silver are 3 to 6-fold higher in spa water than would be anticipated by theoretical calculations based on silver chloride solubility; (4) that due to the unique chemistry of N-halohydantoins such as DCDMH, total chlorine concentrations behave as a chlorine bank that is readily available under conditions requiring high chlorine demand, but without the risk of over chlorination; (5) that spa water treated with N-halohydantoins such as DCDMH is as clear as, if not clearer, then water treated with N-halohydantoins such as BCDMH; and (6) that after spa water has been balanced according to the saturation index, pH remains in a more neutral range (pH 7.4) as compared to spa water treated with N-halohydantoins such as BCDMH.

### Apparatus

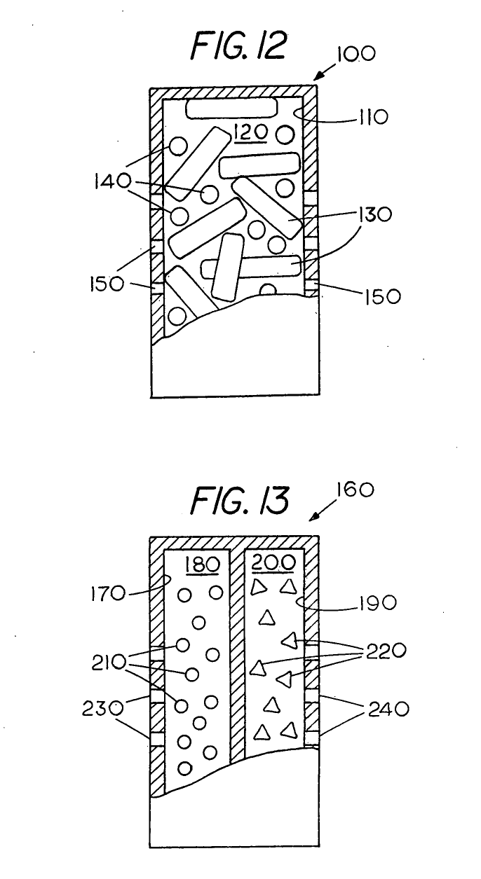

Referring to FIGS. 11 and 12, FIG. 11 shows an embodiment of an apparatus of the present invention comprising a dispenser 100 having a housing 110 containing a compartment 120 therein. Located in compartment 120 is a source of a N-halohydantoin compound such as DCDMH 130 and a bactericide comprising a silver ion donor such as silver chloride 140. A set of openings 150 allows water access to compartment 120 and to the source of DCDMH 130 and the silver chloride 140.

FIG. 12 shows an alternative embodiment of an apparatus of the present invention comprising a dispenser 160 having a first housing 170 containing a compartment 180 and a second housing 190 with a compartment 200 therein. Located in compartment 180 is a silver ion donor such as silver chloride 210 and located in compartment 200 is a source of a N-halohydantoin compound 220. A set of openings 230 allows water access to compartment 180 and to the silver chloride 210. Similarly, a set of openings 240 allows water access to compartment 200 and the source of N-halohydantoin compound 220.

Although FIGS. 11 and 12 shows the use of the silver ion donor as comprising silver chloride, other types of silver ion donors and other alternative bactericides whose solubility can be changed in the presence of N-halohydantoin compound can also be used such as silver bromide.

In regards to the source of N-halohydantoin compound 130,220, FIG. 12 shows the source of N-halohydantoin compound 220 in particle form with the aforementioned particles having an initial size that is larger than the size of opening 230 to prevent the N-halohydantoin compound particles from escaping through opening 230. FIG. 11 shows the source of N-halohydantoin compound 130 in tablet form. Various types of material, including but not limited to microcrystalline cellulose (MCC), may be used as a binder in the formation of the N-halohydantoin compound tablets which are tabletized with the metal ion donor so that both the N-halohydantoin compound and the metal ion donor can be placed in the body of fluid to be treated.

The present invention includes the step of placing the dispenser 100,160 containing both the source of N-halohydantoin compound 130,220 and the silver chloride 140,210 in the body of water such as a body of water support in a spa, hot tub or swimming pool and allowing water to come into contact with the source of N-halohydantoin compound 130, 220 and the silver chloride 140,210 to periodically release N-halohydantoin compound and silver ions into the body of water. As the N-halohydantoin compound is released into the body of water, the N-halohydantoin compound is carried to the silver chloride 140, 210 and interacts with the silver chloride 140,210 to increase the solubility of the silver thereby allowing for the release of more silver ions into the body of water than the silver chloride 140,210 alone.

The present invention can also include a method of treating a body of water to kill microorganisms by maintaining an effective concentration biocides comprising the steps of: (1) adding a silver salt 140,210 to the body of water such as a body of water support in a spa, hot tub or swimming pool; and (2) adding a concentration N-halohydantoin compound 130,220 to the body of water to interact with the silver salt 140,210 to maintain a silver ion concentration effective to kill microorganisms. The aforementioned method can also include the steps of (3) adding silver chloride 140,210 to the body of water; (4) adding silver bromide to the body of water; (5) treating a body of recreational water for at least partial human immersion therein; (6) placing a dispenser 100,160 containing both the silver salt 140,210 and the N-halohydantoin compound 130,220 in the body of water and allowing water to come into contact with both the silver salt 140, 210 and the N-halohydantoin compound 130, 220; (7) adding silver chloride to the body of water on a carrier of limestone; and (8) increasing the temperature of the body of water to increase the dissolution of the N-halohydantoin compound 130,220 in the body of water.

We claim:

1. An antimicrobial method for a structure surface comprising;
forming a structure surface;
applying an antimicrobial agent containing a source of metallic ions and a compound containing a hydantoin ring, which may or may not have antimicrobial properties, to the structure surface whereby the compound containg a hydantoin ring increases the availability of the metallic ions when the antimicrobial agent is in the presence of a liquid.

2. The antimicrobial method for a structure surface of claim 1 wherein the source of metallic ions in the antimicrobial agent includes a transition metal, a transition metal oxide, a transition metal salt, or a combination thereof.

3. The antimicrobial method for a structure surface of claim 2 wherein the step of adding the transition metal, the transition metal oxide, the transition metal salt, or a combination thereof to the comprises adding silver, silver oxide, silver salt, or a combination thereof to the antimicrobial agent before applying the antimicrobial agent to the structure surface.

4. The antimicrobial method for a structure surface of claim 1 including the step of increasing the effectiveness of the antimicrobial agent through introduction of water to the antimicrobial agent.

5. The antimicrobial method for a structure surface of claim 4 wherein the antimicrobial agent is a water base solution containing silver chloride and applying the water base solution containing the silver chloride and a compound containing a hydantoin ring to a structure surface and allowing the water base solution to evaporate to leave the antimicrobial agent in an activateable state.

6. The antimicrobial method for a structure surface of claim 5 wherein the step of adding the antimicrobial agent to the structure surfaces comprises applying the antimicrobial agent to the structure surface and then enclosing the structure surface.

7. The antimicrobial method for a structure surface of claim 1 wherein the compound containing a hydantoin ring is a halogenated hydantoin selected from the group consisting of Bromochlorodimethylhydantoin (BCDMH), Dichlorodimethylhydatoin (DCDMH), and Dibromodimethylhydantoin (DBDMH).

8. The antimicrobial method for a structure surface of claim 1 wherein the antimicrobial agent is applied to the structure surfaces a water base solution and the water is allowed to evaporate leaving a coating of the antimicrobial agent on the structure surface.

9. The antimicrobial method for a structure surface of claim 1 wherein the antimicrobial agent is incorporated into structure surface during formation of the structure surface.

10. A building wherein the building includes a plurality of indoor and outdoor surfaces each having a structure surface with an antimicrobial agent located on the indoor and outdoor surfaces of the building wherein the antimicrobial agent comprise silver chloride with the solubility of silver in water limiting the concentration of available silver for killing bacteria on the indoor and outdoor surfaces and a compound containing a hydantoin ring comprising 5-5 dimethylhydantoin wherein the 5-5 dimethylhydantoin lacks biocidal properties but the combination of the sliver chloride and 5-5 dimethylhydantoin increases the ability of the antimicrobial agent to destroy harmful bacteria or microorganisms by increasing the availability of silver ions during the presence of moisture on the indoor or outdoor surface.

11. The building product of claim 10 wherein the building product surface is a component of the building.

12. The building product of claim 10 including a liquid on the structure surface whereby the liquid comprises a water based solution containing an antimicrobial agent and a compound containing a hydantoin ring.

13. The building product of claim 12 wherein the antimicrobial agent includes a source of silver ions.

14. The building product of claim 12 wherein the compound containing a hydantoin ring comprises 5,5-dimethylhydantoin and the biocidal metal comprises a source of silver.

15. A bacteria and microorganism killing zone proximate a structure surface wherein the killing zone includes a region on the structure surface; and
an antimicrobial agent located in the region on the structure surface with the antimicrobial agent including a source of metal ions and a compound containing a hydantoin ring, wherein the presence of water increase a level of metal ions in the killing zone.

16. The bacteria and microorganisms killing zone of claim 15 wherein the source of metal ions is silver chloride and the compound containing the hydantoin ring is dimethyl hydantoin.

17. The bacteria and microorganisms killing zone of claim 15 wherein the antimicrobial agent adheres to the structure surface and the region on the structure surface includes a water wetted structure surface whereby the level of metal ions in the water wetted structure surface is greater than if the surface were unwetted.

18. The bacteria and microorganisms killing zone of claim 17 wherein the water-wetted structure is an interior building surface.

19. The bacteria and microorganisms killing zone of claim 17 wherein the bacteria and microorganisms killing zone expands or contracts in response to an area of the water wetted structure surface.

20. The structure surface antimicrobial method of claim 1 wherein the structure surface is an article of furniture and the step of treatment to lessen or prevent growth of bacteria includes of applying an antimicrobial agent to the structure surface wherein the antimicrobial agent includes a biocidal meal and a compound containing a hydantoin ring.
